(19) United States
(12) Patent Application Publication
(10) Pub. No.: US 2009/0088997 A1
(43) Pub. Date: Apr. 2, 2009

(54) DATA PROCESSING SYSTEM

(75) Inventors: Masaaki KIKUCHI, Hitachinaka (JP); Takahiro Osono, Mito (JP)

Correspondence Address: MCDERMOTT WILL & EMERY LLP, 600 13TH STREET, N.W., WASHINGTON, DC, 20005-3096, US

(73) Assignee: HITACHI HIGH TECHNOLOGIES CORPORATION

(21) Appl. No.: 12/211,437

(22) Filed: Sep. 16, 2008

(30) Foreign Application Priority Data
Sep. 28, 2007 (JP) 2007-252978

(51) Int. Cl. G06F 19/00

(52) U.S. Cl. 702/81

(57) ABSTRACT

A data processing system manages data of inspection conditions of a plurality of inspection devices. The system includes a storage device, a computing device, and an input/output device. The storage device stores therein data of master inspection conditions of one of the plurality of inspection devices for use as reference data in data comparison and data of comparison target inspection conditions of one or more of the others of the plurality of inspection devices. The input/output device displays thereon names of the master inspection conditions and names of the comparison target inspection conditions in the form of lists arranged side by side, and concurrently displays thereon one of the master inspection conditions and a selected comparison target inspection condition(s) of a comparison target inspection device(s) in a display mode distinguished from a display mode applied for other inspection conditions.

### BACKGROUND OF THE INVENTION

1. Field of the Invention

The present invention relates to a system of executing processing of multiple pieces of inspection condition data related to a semiconductor inspection device.

2. Description of the Related Art

In recent years, with enhancement in functional capability and multifunctionality of electronic devices, also inspection procedures for semiconductor devices have become complex. As such, taking appropriate countermeasures against, for example, increase in the types of manufacturing items and complex inspection procedures are important issues in plants of semiconductor device manufacturers. Hence, inspection condition data to be used in a semiconductor inspection device are increasingly complex, and the amount of data is increasing. An inspection condition is generally called “recipe,” such that inspection condition data hereinbelow will be referred to as “recipe data.” Conventionally, recipe data has mainly been manually managed. While development of techniques for enabling computer management of recipe data is in progress, it cannot be said that the current progress state is sufficient.

Effective recipe data maintenance produces a state where recipe data is managed in a unitary manner in units of, for example, an inspection step, corrections incorporating conditions per semiconductor inspection device are reflected into recipe data, and the locations and usages of multiple pieces of recipe data are clearly defined.

An automation system for systematic classification and re-arrangement of a massive number of recipe data resources already used has not been implemented to date. This is because the relations among data structures in recipe data are complex. More specifically, in the case of recipe data, recipe management data, wafer map data, measurement point management data, and measurement point data relate to multiple data structures in an organic fashion, and a large number of parameters that constitute the data structures are present, such that innumerable correlative comparison classification patterns are present.

As an example method related to structured documents, methods of comparison of data having complex structures include a method of the type such as described in Patent Publication 1 (Japanese Unexamined Patent Application Publication No. 1996-329079). In the event of classification and re-arrangement of recipe data, it is necessary to realize a series of processing modes to correction of recipe data by taking into account designation and collection of comparison target recipe data, comparison differential detection, and differential results. In this event, when the method described in Patent Publication 1 is applied, points described herebelow remain as problem pending resolution.

A first point relates to processing devices (means) for comparison differential detection. While comparison processing can be performed only when a prerequisite condition of the data structure is the presence of elements thereof, comparison processing cannot be performed to detect matching items inclusive of the presence or-absence of data instances, as in the case of measurement points of a wafer. Further, the method is not adaptable to a data structure of two-dimensional table data such as wafer map data.

A second point is that the differential results cannot be correlated to a correlation processing device (means). In this case, the correlation processing device (means) refers to a device (means) that causes, for example, a data position of a target parameter and an operation screen to be correlated to one another in accordance with the differential result and that uses this function.

A third point is that since a method for designation and collection of comparison target data is not described in Patent Publication 1, it remains as a problem pending resolution.

### SUMMARY OF THE INVENTION

An object of the present invention is to provide a data processing system that clearly defines a recipe differential through recipe comparison processing, that enables designation, classification, and the like of a necessary recipe to be effectively performed, and that contributes to improvement in the efficiency of recipe management and unitary management of recipes.

According to one embodiment of the present invention, there is provided a data processing system for managing data of inspection conditions of a plurality of inspection devices. The data processing system includes a storage device, a computing device, and an input/output device. The storage device stores therein data of master inspection conditions of one of the plurality of inspection devices for use as reference data in data comparison and data of comparison target inspection conditions of one or more of the others of the plurality of inspection devices. The input/output device displays thereon names of the master inspection conditions and names of the comparison target inspection conditions in the form of lists arranged side by side, and concurrently displays thereon one of the master inspection conditions and a selected comparison target inspection condition(s) of a comparison target inspection device(s) in a display mode distinguished from a display mode applied for other inspection conditions.

According to another embodiment of the present invention, there is provided a data processing system for managing data of inspection conditions of a plurality of inspection devices. The data processing system includes a storage device, a computing device, and an input/output device. The computing device performs designation and collection of comparison target data in regard to inspection conditions of the plurality of inspection devices, performs a comparison of data, causes a differential parameter obtained as a result of the comparison and an operation screen displayed on the input/output device to be displayed in association with one another, and causes displaying a parameter operation screen for operating a parameter of an inspection condition inclusive of a differential parameter specified on a screen of the input/output device.

According to the present invention, the comparison (comparison processing) makes recipe differentials to be clear, whereby designation, classification, and the like of necessary recipes can be efficiently performed. Consequently, a data processing system contributing to improvement of efficiency of recipe management and unitary recipe management can be provided.

### BRIEF DESCRIPTION OF THE DRAWINGS

In the accompanying drawings:

FIG. 1 is a view showing the overall configuration of a recipe comparison system;

FIG. 2 is a flow chart showing a processing flow of comparison detection of recipe management data;

FIG. 3 is a flow chart showing a processing flow of comparison detection of wafer map data;

FIG. 4 is a flow chart showing a processing flow of comparison detection of measurement point data;

FIG. 5 is a flow chart showing an improved processing flow of comparison detection of measurement point data;

FIG. 6 is a view of an example screen related to execution specification for selection of master recipe data and comparison target recipe data;

FIG. 7 is a diagram of a data tree showing an example of implementation of a processing flow of measurement point parameter comparison;

FIG. 8 is a view of an example screen displaying the results of recipe comparison;

FIG. 9 is a view of an example editing screen for editing a master recipe inclusive of parameter values of master recipe data in a column of Master Recipe; and

FIG. 10 is a view of an example editing screen for editing a master recipe inclusive of parameter values of master recipe data in a column of Master Recipe.

### DETAILED DESCRIPTION OF THE PREFERRED EMBODIMENTS

One embodiment of the present invention will be described with reference to the accompanying drawings. The present embodiment relates to a recipe comparison system for an inspection device for semiconductor devices. A “recipe” refers to an inspection condition of the semiconductor inspection device, and “recipe data” refers to set-up data of an inspection condition. The recipe comparison system is executed in a mode that, in a state where a process-execution dedicated PC (personal computer) and multiple semiconductor inspection devices are network-connected, recipe data are collected from the semiconductor inspection devices into the process-execution dedicated PC. The process-execution dedicated PC hereinbelow will be alternatively referred to as a “recipe comparison control apparatus.”

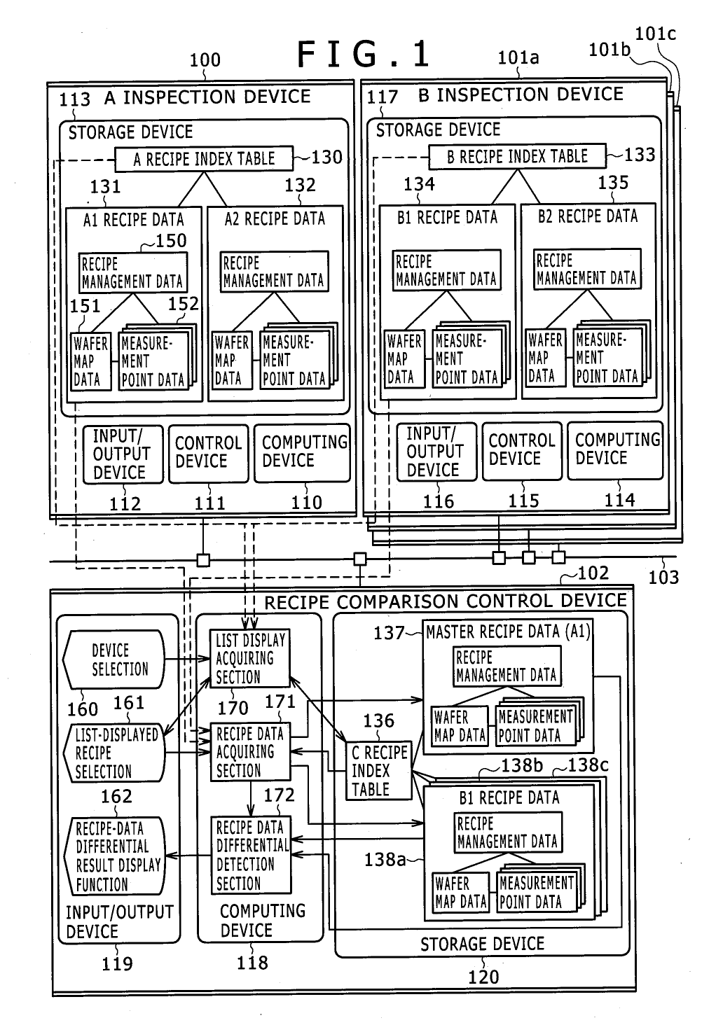

FIG. 1 is a view showing the overall configuration of a system that executes recipe comparison processing (which system hereinbelow will alternatively be referred to as a “recipe comparison system). The overall system is configured to include a recipe comparison control apparatus 102 that controls of recipe comparison processing and multiple inspection devices, namely, an A inspection device 100, a B inspection device 101a, a C inspection device 101b, and a D inspection device 101c. The respective devices are network-connected via a hard-wired, intra-company local area network (LAN) or wide area (WAN) 103.

Next, an interior configuration of the recipe comparison control apparatus 102 will be described hereinbelow. The recipe comparison control device 102 is configured to include an input/output device 119, a computing device 118, and a storage device 120. The recipe comparison processing is executed by the devices 118 to 120 in an integral manner. Further, in the event of processing of recipe data comparison across the semiconductor inspection apparatuses, comparison processing is executed while target recipe data are being transferred to and collected in the recipe comparison control device 102. Broken line portions of FIG. 1 are indicative that recipe index tables and recipe data are transferred from the semiconductor inspection devices to the recipe comparison control device 102.

The input/output device 119 is configured to include a device selection function 160 and a list-displayed recipe selection function 161 that select a recipe-comparison target semiconductor inspection device, and a recipe-data differential result display function 162 that displays a recipe comparison result. The computing device 118 is configured to include a list display acquiring section 170 that acquires a recipe-list related recipe index table from the respective semiconductor inspection device, a recipe data acquiring section 171 that acquires recipe data from the respective semiconductor inspection device, and a recipe data differential detection section 172 that executes comparison processing of recipe data retained in the recipe comparison control device 102.

The recipe index table is a recipe data composition table that contains descriptions of internal compositions and in-device storage device storage positions of recipe data. More specifically, the table contains components, such as a recipe management data name, wafer map data name, measurement point data name, management class name, semiconductor inspection device name, and storage device storage positions, for example.

The storage device 120 stores recipe index tables collected by being transferred from the semiconductor inspection devices and recipe data. FIG. 1 shows an instance in which a C recipe index table 136 manages master recipe data 137 and multiple pieces of recipe data 138a, 138b, and 138c.

The system configuration on the semiconductor inspection device side will be described hereinbelow. The A inspection device 100 is configured to include an input/output device 112, a control device 111, a computing device 110, and a storage device 113. Similarly, the multiple inspection devices, namely, the B to D inspection devices 101a to 101c are connected and each have the same configuration as the A inspection device 100. The input/output device 112 has functions of, for example, inputting of an execution specification for inspection and measurement and displaying of images of inspection and measurement results.

The control device 111 has functions of executing inspection and measurement along with recipe data specified from the input/output device 112. The computing device 110 has functions of executing various operations, such as image classification and collation in accordance with the inspection and measurement results. The storage device 113 is configured to include an A recipe index table 130 that manages a recipe list, an A1 recipe data 131, and an A2 recipe data 132, in which recipe data are efficiently stored and managed.

The recipe data shown in FIG. 1 is composed to further include multiple data elements. An instance thereof will be described in conjunction with the Al recipe data 131 of the A inspection device 100. The recipe data is composed to include recipe management data 150, wafer map data 151, and measurement point data 152. The recipe management data 150 includes attributes for management of data, such as wafer map data names and measurement point data names, and associated parameters that are used for recipe execution. The wafer map data is data representing a wafer map. The measurement point data includes multiple parameters, such as information of chip coordinate positions on the wafer and measurement types, necessary for measurement.

Next, a processing procedure of the recipe comparison processing will be described with reference to FIG. 1. Activation of the processing is executed from a device selection function 160 of the input/output device 119 of the recipe comparison control device 102, in which an operator appropriately selects a comparison target semiconductor inspection device. The list display acquiring section 170 of the computing device 118 accesses the selected semiconductor inspection device, acquires a recipe index table being managed therein, and transfers the acquired table to the recipe comparison control device 102. In FIG. 1, there is shown the instance in which the recipe index table 130 of the storage device 113 of the A inspection device 100 is transferred to the storage device 120 of the recipe comparison control device 102. Further, a B recipe index table 133 in a storage device 117 of the B inspection device 101a is transferred to the storage device 120 of the recipe comparison control device 102. Similarly, index tables of the respective C inspection device 101b and D inspection device 101c are transferred to the storage device 120. The multiple index tables thus transferred are merged into the C recipe index table 136 of the storage device 120 of the recipe comparison control device 102. When identical recipe data is already present in the C recipe index table 136, the recipe data is updated by being with transferred recipe data. Otherwise, when no identical recipe data is present therein, new recipe data is stored thereinto.

The list display acquiring section 170 first reads the C recipe index table 136, formats the C recipe index table 136 into a selection-target recipe list, and displays the list on the list-displayed recipe selection function 161 of the input/output device 119. Then, multiple pieces of recipe data of interest for comparison are selected from the list being displayed on the list-displayed recipe selection function 161.

In accordance with the selected recipe data information, the recipe data acquiring section 171 searches the contents of the C recipe index table 136 with a name of the selected recipe data, thereby to detect and extract the name of a semiconductor inspection device being under management. By use of the name of the detected name of the semiconductor inspection device and the name of the detected recipe data as keys, the recipe data acquiring section 171 accesses the target semiconductor inspection device, and transfers the target recipe data to the storage device 120 of the recipe-comparison control device 102. In the instance shown in FIG. 1, suppose that the name of selected recipe data corresponds to the A1 recipe data, and the semiconductor inspection device corresponding thereto is the A inspection device 100. In this case, the A inspection device 100 is accessed, the A1 recipe data 131 under the management of the storage device 113 is transferred to the storage device 120 of the recipe comparison control device 102, and is then stored thereinto as A1 recipe data 137. The A1 recipe data 137 is used as master recipe data that serves as a reference for comparison-target recipe data.

Next, an acquiring method for acquiring multiple pieces of recipe data for comparison with the master recipe data will be described hereinbelow. In the instance shown in FIG. 1, suppose that the name of selected recipe data corresponds to the B1 recipe data, and the semiconductor inspection device corresponding thereto is the B inspection device 101a. In this case, similarly as the A1 recipe data, the B inspection device 101a is accessed, B1 recipe data 134 under the management of the storage device 117 is transferred to the storage device 120 of the recipe comparison control device 102, and is then stored thereinto as B1 recipe data 138a. Similarly, the other multiple semiconductor inspection devices are accessed, and recipe data 138c and 138d are stored into the storage device 120.

After the execution of the recipe data acquiring section 171, the recipe data differential detection section 172 is called or invoked. The recipe data differential detection section 172 performs comparison of the A1 recipe data 137 with the multiple pieces of recipe data 138a, 138b, and 138c, and the process results are output to the recipe-data differential result display function 162 of the input/output device 119.

According to the present embodiment of the present invention, with the system configuration of the recipe comparison system and the recipe comparison processing procedure, the recipe data comparison processing can be specified to be executed in a network equivalent manner without being conscious of a physical position of a recipe data management device. Thereby, detection of inter-recipe data differentials can be ascertained.

Further, the present invention has a feature that, for example, detection of insufficient recipe parameters and determination of whether matching with master recipe data having actual productivity can be accomplished for multiple pieces of recipe data that scatter in and across semiconductor inspection devices and that are hence difficult to be identified.

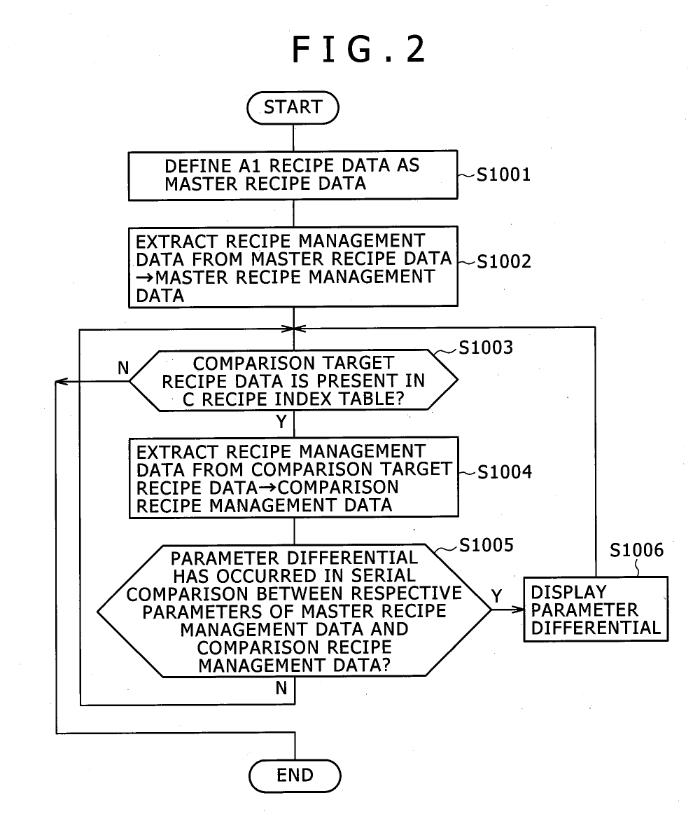

Next, processing flows of recipe data differential detection shown in FIGS. 2 to 5 will be described herebelow. The respective processing flows of respective recipe data differential detection represent internal processing algorithms of the recipe data differential detection section 172 shown in FIG. 1. The respective processing flows of recipe data differential detection section flow execute the processing in units of data element composing recipe data. More specifically, since the recipe data is composed to include the recipe management data, the wafer map data, and the measurement point data, the respective processing flows shown in FIGS. 2 to 5 are executed in units of the composition element or component.

FIG. 2 is a flow chart showing a processing flow of comparison detection of recipe management data. The recipe management data is composed to include the name of wafer map data, the name of measurement point data, and in addition, multiple associated parameters that are used to control the entirety of the recipe entirety. Further, these parameters are managed by being correlated to the name of the parameter and multiple parameter values corresponding thereto. To begin with, A1 recipe data is defined to be master recipe data (step S1001). Then, recipe management data is extracted from the master recipe data, and is defined to be master recipe management data (step S1002). Then, it is checked whether the name of comparison target recipe data is present in the C recipe index table 136 (step S1003). If the name of comparison target recipe data is present, recipe management data is extracted from the comparison target recipe data, and is defined to be comparison recipe management data (step S1004). The master recipe management data and the comparison recipe management data contain same number of managed parameters. These parameters are serially retrieved and cross-checked (step S1005). In the event that parameter values are different from one another, the target parameter information is stored into a storage area in a main storage device, such as, for example, a temporal-use storage area in the computing device 118 of the computing device 118 shown in FIG. 1. Concurrently, the information is displayed on the recipe-data differential result display function 162 (step S1006). Finally, in the event that all have been subjected to the comparison processing against the names of recipe data in the C recipe index table 136, the processing flow terminates.

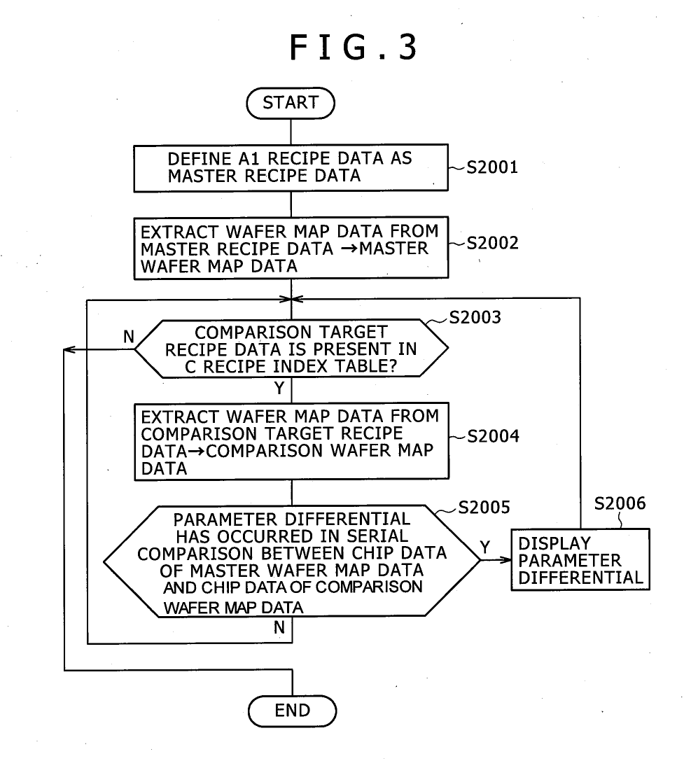

FIG. 3 is a flow chart showing a processing flow of comparison detection of wafer map data. The wafer map data is composed to include chip data having two-dimensional arrangement in X and Y directions that define in-wafer measurement effective areas. A flag value indicative of whether a measurement effectiveness or ineffectiveness (“measurement effectiveness or ineffectiveness flag,” herebelow) is set in the chip data.

To begin with, A1 recipe data is defined to be master recipe data (step S2001). Then, wafer map data is extracted from the master recipe data, and is defined to be master wafer map data (step S2002). Then, it is checked whether the name of comparison target recipe data is present in the C recipe index table 136 (step S2003). If the name of comparison target recipe data is present, wafer map data is extracted from the comparison target recipe data, and is defined to be comparison wafer map data (step S2004). If the numbers of chips and the numbers of the X and Y directions of the respective wafer map data and comparison wafer map data match with one another, the measurement effectiveness or ineffectiveness flags are serially cross-checked (step S2005). As a result, in the event that the parameter values are different from one another, the target parameter information is stored into a storage area in a main storage device, such as, for example, a temporal-use storage area in the computing device 118 of the recipe comparison control device 102 shown in FIG. 1. Concurrently, the information is displayed on the recipe-data differential result display function 162 (step S2006). If the parameter values are identical to one another, the processing flow returns to step S2003. Finally, in the event that all have been subjected to the comparison processing against the names of recipe data in the C recipe index table 136, the processing flow terminates.

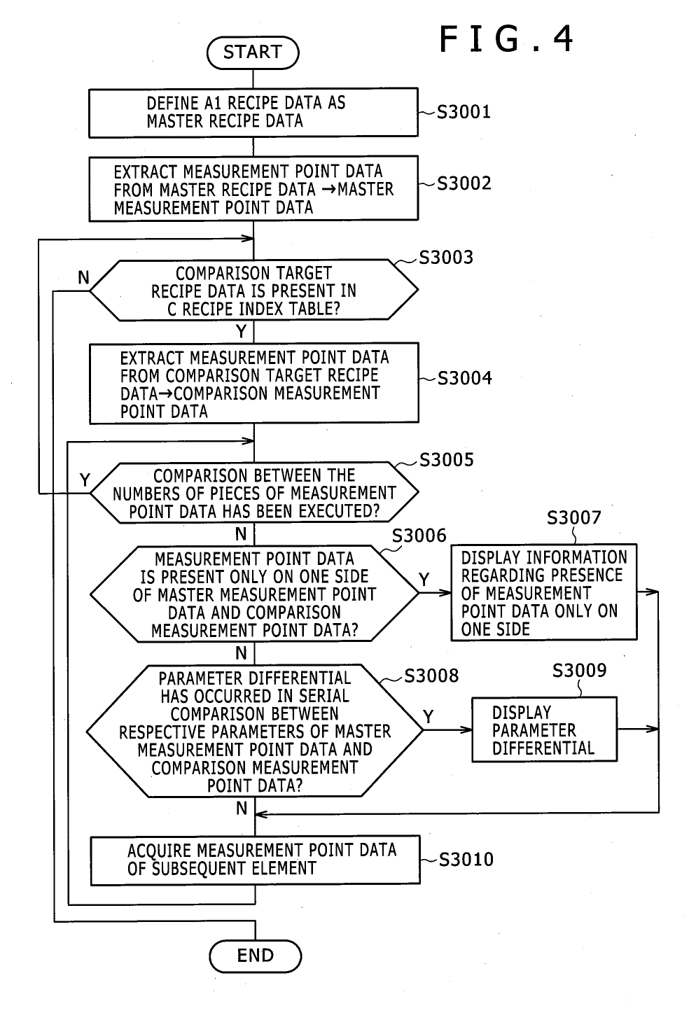

FIG. 4 is a flow chart showing a processing flow of comparison detection of measurement point data. The measurement point data defines inspection conditions in regard to the chip data that contains the measurement effectiveness flag and that is specified with the wafer map data, and multiple pieces of measurement point data corresponding to the number of measurement-effective chips are present. Further, the respective measurement point data includes multiple inspection condition parameters.

To begin with, A1 recipe data is defined to be master recipe data (step S3001). Then, measurement point data is extracted from the master recipe data, and is defined to be master measurement point data (step S3002). Then, it is checked whether the name of comparison target recipe data is present in the C recipe index table 136 (step S3003). If the name of comparison target recipe data is present, measurement point data is extracted from the comparison target recipe data, and is defined to be comparison measurement point data (step S3004). Since multiple pieces of measurement point data are present, it is checked whether comparison processing in regard to the master measurement point data and comparison measurement point data has been executed for the number of the pieces of the present (or existing) measurement point data (step S3005). In the event that comparison processing has been executed for the number of pieces of the present measurement point data, the processing flow returns to step S3003 at which next recipe data is acquired. Otherwise, in the event that comparison processing is not as yet execution for the number of pieces of the present measurement point data, checking is performed to determine the presence or absence of identical measurement point data in regard to the master measurement point data and the comparison measurement point data (step S3006). As a consequence, in the event of measurement point data present only on one side of the master measurement point data and the comparison measurement point data, target measurement point data information is stored into a storage area in the main storage device, such as a temporal-use storage area in the computing device 118 of the recipe comparison control device 102 shown in FIG. 1. Concurrently, the information is displayed on the recipe-data differential result display function 162 (step S3007).

Otherwise, in the event that the target is identical measurement point data, the respective parameters of the master measurement point data and the comparison measurement point data are serially cross-checked (step S3008). As a result, in the event that parameter values are different from one another, the target parameter information is stored into a storage area in the main storage device, such as, for example, a temporal-use storage area in the computing device 118 of the recipe comparison control apparatus 102 shown in FIG. 1. Concurrently, the information is displayed through the recipe-data differential result display function 162 (step S3009). After completion of serial parameter checking for the target measurement point data, next measurement point data is acquired (step S3010). In the event that, after completion of executing comparison for all measurement point data (step S3005), all have been subjected to the comparison processing against the names of recipe data in the C recipe index table 136 (step S3003), the processing flow terminates.

In the serial parameter comparison processing at step S3008 of FIG. 4, the number of the parameters of the measurement point data is large, such that a large number of parameter differentials are displayed depending upon the case. Further, as the number of pieces of measurement point data increases, also the number of parameter differentials significantly increases. Hence, there arises a new problem that it takes time for a user to perform, for example, verification and analysis of parameter differentials. However, the number of parameter differentials for display can be reduced by improving the processing flow of detecting differentials between the parameters of the measurement point data.

Measurement point parameters are categorized into related determination key parameters and dependent parameters. The related determination key parameters determine measurement conditions. The dependent parameters are determined in association with fixing of a related determination key string. An example of a basic composition of the parameters is shown in Expression (1) below.

(S1, S2, S3)→(C1, C2, C3, C4) (1)

S1 to S3 each represents a related determination key parameter, and the string (S1, S2, S3) is defined as a related key parameter string. C1 to C4 each represents a dependent parameter, and the respective dependent parameters are uniquely determined in relation to the related key parameter string. The string (C1, C2, C3, C4) is defined as a dependent parameters string.

In the case of the conditions of Expressions (2) and (3) based on Expression (1), comparison processing is executed in accordance with Expression (4).

(Sa1, Sa2, Sa3)→(C1a, C2a, C3a, C4a) (2)

(Sb1, Sb2, Sb3)→(C1b, C2b, C3b, C4b) (3

(Sa1=Sb1)̂(Sa2=Sb2)̂(Sa3=Sb3) [symbol] Comp(C1a, C1b)vComp(C2a, C2b)vComp(C3a, C3b)vComp(C4a, C4b) (4)

In the above, Comp(X, Y) represents a function for comparing the parameter values X and Y.

In the event that measurement point data a and measurement point data b are represented by Expression (2) and (3), the related parameters are serially compared. The comparison is performed for the respective parameters Sa1 to Sa3 of Expression (3) and the respective parameters Sb1 to Sb3. In the event that all the related parameters are equal, all the dependent parameters C1a to C4a and C1b to C4b are compared with one another. However, in the event that the related key parameter strings do not satisfy Expression (4), comparison of the dependent parameters are unnecessary. Hence, comparison processing of the related key parameters is cancelled, and the operation moves to comparison of next measurement point data, thereby reducing the number of comparisons of dependent parameters.

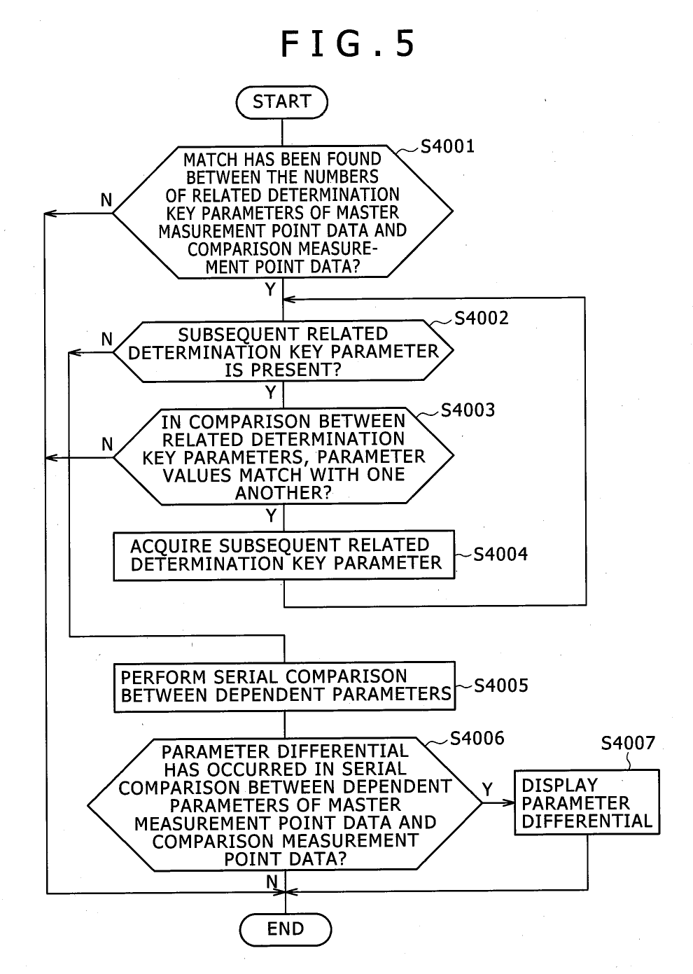

FIG. 5 is a flow chart showing an improved processing flow of comparison detection of measurement point data, in which the conditions of Expressions (1) to (4) are incorporated. The processing replaces steps S3008 and S3009 of FIG. 4.

To begin with, it is checked whether there is a match between the numbers of related key parameters of the master measurement point data and the comparison measurement point data (step S4001). If there is no match, processing terminates. Otherwise, if there is the match, then it is verified whether a related determination key parameter of a related determination key parameter string is present (step S4002). If present, then the related determination key parameters are serially compared with one another (step S4003). If the parameter values are identical to one another, then subsequent related determination key parameters are acquired (step S4004). If all related determination key parameters match with one another, then dependent parameters are serially compared with one another (step S4005). In the event that, at step S4003, there are non-matching values in the related determination key parameters, processing terminates without executing serial comparison of the dependent parameters.

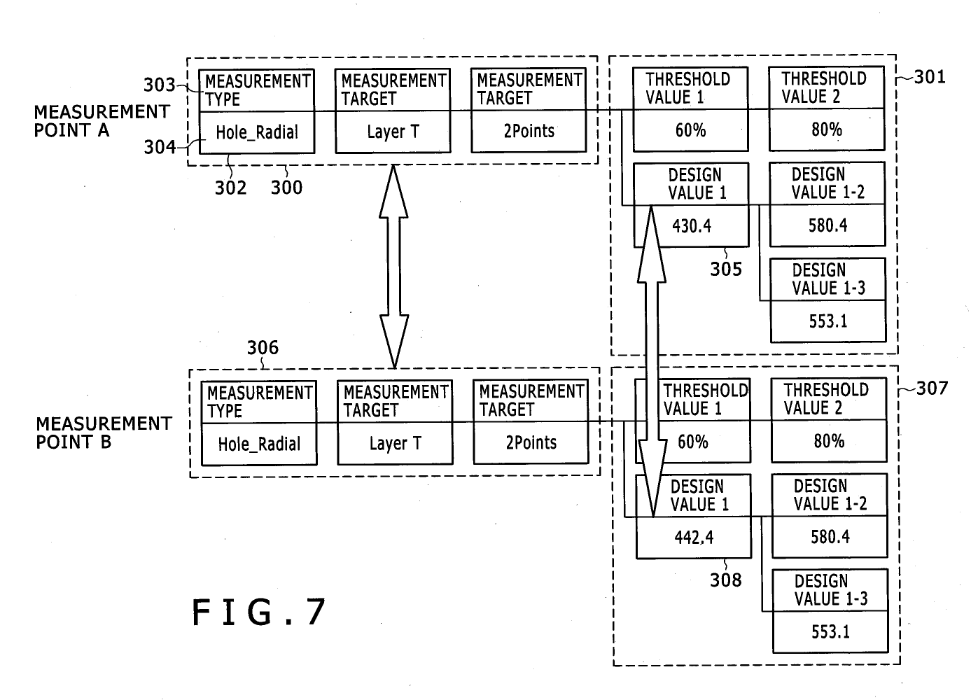

In the event that dependent parameters are different from one another, the target parameter information is stored into the main storage, and then is displayed on the recipe-data differential result display function 162 (step S4007). Implementation examples of the comparison flows will be described in detail below with reference to FIG. 7.

As described above, the recipe data differential detection section 172 shown in FIG. 1 is operated to execute processing in accordance with the series of the processing flows shown in FIGS. 2 to 5.

Next, example cases (or instances) of operation of comparison or comparison processing between a master recipe data and multiple pieces of recipe data will be described with reference to operation screens (examples). The respective screens are displayed on a display of the input/output device 119 of the recipe comparison control device 102 shown in FIG. 1. Also, inputting or input operation using, for example, a screen and/or keyboard is carried out by use of the input/output device 119.

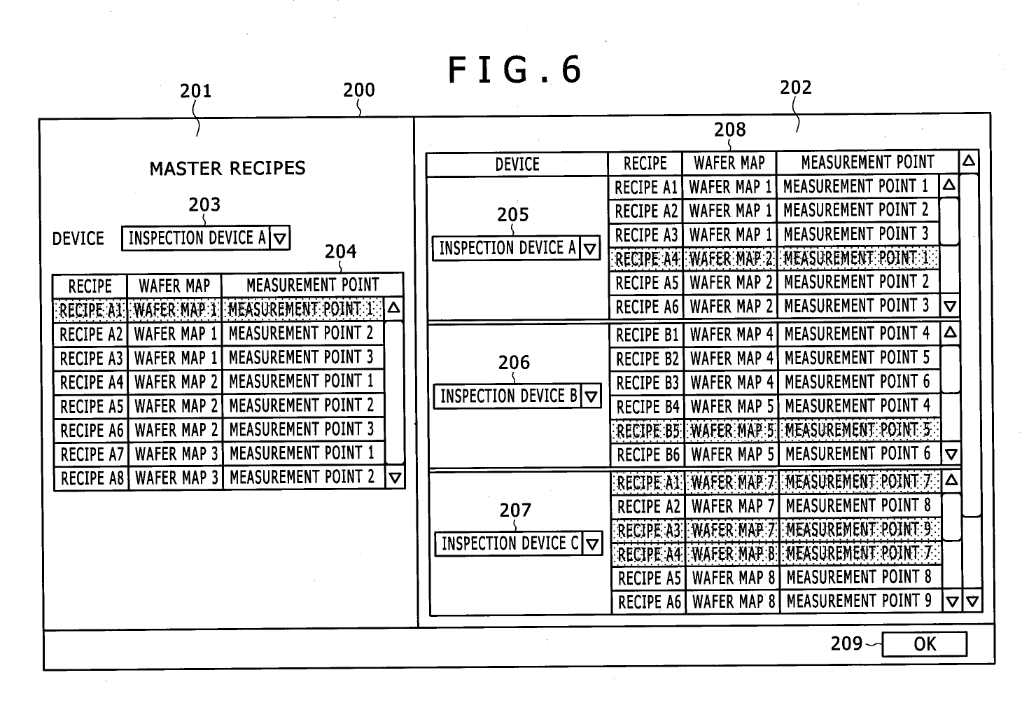

FIG. 6 is a view of a screen 200 showing an example related to execution specification for selection of master recipe data and comparison target recipe data. With reference to FIG. 6, a master recipe field section 201 is a field for the use of selecting master recipe data, which is used as comparison reference. A comparison target recipe selection field section 202 is a field for the use of selecting multiple comparison target recipes. In the screen 200, the master recipe field section 201 and the comparison target recipe selection filed section 202 are displayed side by side.

A device list box 203 in the master recipe field section 201, a list of the names of registered semiconductor inspection devices and recipe comparison control devices on the network is displayed, in which an operator selects the name of a necessary device. A master recipe list 204 displays a list of the types of recipes, wafer maps, and measurement points corresponding to a semiconductor inspection device or recipe comparison control device selected from the device list box 203. Thus, in the present embodiment, the method of device selection from the list box is described and shown as a method of device selection. However, the method may be any one of a method allowing selection from a displayed list of devices, a method allowing selection by use of a check mark in a check box, and a method allowing selection by providing option buttons.

With reference to FIG. 6, it is here assumed that an operator desires to select a recipe A1 from multiple lines of a table displayed master recipe list 204. In this case, when one of the lines is selected through, for example, clicking thereon, the selected line is displayed to be distinguished from the other lines. For displaying such a selected line, various methods can be considered. For example, methods of using the reverse-video display mode, changing the background color, changing the font color, using a bold font, using an oblique or italicized font, changing the font size, and framing selected portions can be considered. Further, in the present embodiment, the example method in which the line of interest is selected by clicking thereon is described and shown. However, the method may be such that, for example, check boxes are provided on the left side of the table, in which a recipe such as the recipe A1 is selected by a check mark is put in a check box corresponding thereto.

The number of selectable recipe from the master recipe list 204 is one. Hence, in the event that a different line is selected by clicking thereon in the state where an arbitrary line of the master recipe list 204 has been selected, while the selection state of the originally selected line is cancelled, the newly selected different line becomes in the selection state. Further, the method may be such that the selection state of a selected line is cancelled when the selected line is selected by re-clicking thereon.

The comparison target recipe selection field section 202 is a field for the use of selecting multiple comparison target recipes, in which a comparison target recipe list 208 is displayed. In the comparison target recipe list 208, multiple device list boxes 205 to 207 are displayed, in which the names of registered semiconductor inspection devices on the network and of the recipe comparison control device 102 are list-displayed therein.

The operator uses the respective device list boxes 205 to 207 in the comparison target recipe list 208 to select devices that correspond to recipes desired to be operated. The number of selectable devices in one device list box is one. In the comparison target recipe list 208, recipes, wafer maps, and measurement points corresponding to selected devices are displayed in a list format. For device selection, the present embodiment employs the method of selection from the respective list boxes. However, the method may be any one of, for example, a method in which a list of the names of devices are preliminarily provided to be selectable from the list or to be selectable by putting check marks, and a method in which such a list of the names of devices are provided with option buttons for selection.

The operator is allowed to select one or more desired recipes in units of one device. In this case, when at least one line of the comparison target recipe list 208 is selected by clicking thereon, a recipe on the line is selected. The method for displaying such line selection may be any one of, for example, methods of using the reverse-video display mode, changing the background color, changing the font color, using a bold font, using an oblique or italicized font, changing the font size, and framing selected portions. Further, in the present embodiment, the example method in which the line of interest is selected by clicking thereon is described and shown. However, the method may be such that selection is made by using check boxes.

In the comparison target recipe list 208, multiple lines (recipes) corresponding to one device can be selected. For example, in the event that a semiconductor inspection device or recipe comparison control device has been selected from the device list box 205, multiple lines can be selected from the displayed comparison target recipe list 208. In this case, when arbitrary two lines are selected while a Shift key on a keyboard is kept depressed, all lines inclusive and between the selected two lines can be selected. Although the Shift key is allocated in the present embodiment, a different key may be allocated. Alternatively, the method may be such that multiple lines are selected through dragging and dropping.

When a line in the selected state is selected by re-clicking on, the selection state is cancelled. The method may be such that when a different line is selected by clicking thereon, the selection state of the originally selected line is cancelled, and the newly selected different line becomes in the selection state. In this case, when arbitrary lines are selected by clicking thereon while a Ctrl key on the keyboard is kept depressed, multiple lines can be selected. Although the Ctrl key is allocated in the present embodiment, a different key may be allocated. Further, multiple recipes corresponding to multiple semiconductor inspection devices or recipe comparison control devices can be selected and cancelled.

In FIG. 6, device selection can be made in such a manner that, for example, different semiconductor inspection devices or recipe comparison control devices are selected from the respective device list boxes 205 to 207, and desired recipes are selected from the respective displayed comparison target recipe lists 208. There are displayed the respective names of recipes, wafer maps, and measurement points of an inspection device A selected from the device list box 205, in which a recipe A4 is selected. Further, there are displayed the respective names of recipes, wafer maps, and measurement points of an inspection device B selected from the device list box 206, in which a recipe B5 is selected. Further, there are displayed the respective names of recipes, wafer maps, and measurement points of an inspection device B selected from the device list box 207, in which recipes A1, A3, and A4 are selected.

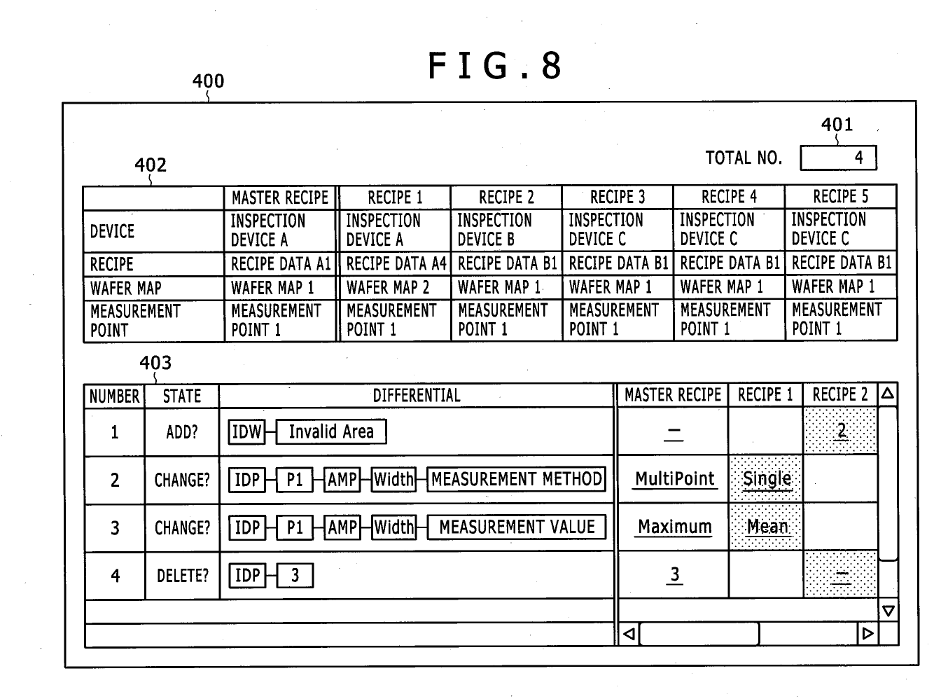

As described above, after selection of the master recipe data and multiple pieces of recipe data, an OK button 209 is pressed. Thereafter, measurement point parameter comparison processing of measurement point parameters of selected recipe data shown in FIG. 7 is executed, and a screen shown in FIG. 8 is displayed as comparison results. The measurement point parameter comparison processing is executed in the computing device 118 of the recipe comparison control device 102 shown in FIG. 1, and the comparison results are displayed on the display of the input/output device 119.

FIG. 7 is a diagram of a data tree showing an example of implementation of the flow of measurement point parameter comparison. A related determination key parameter 300 is an item working as a key that constitutes a tree of a measurement point A. A dependent parameter 301 is determined in association with the related determination key parameter. In FIG. 7, an item 302 configuring a measurement point is represented by a measurement type item name 303, and a “Hole_Radial” attribute 304. Further, in a manner similar to the above, all items are each represented by an item name and an attribute.

In the event of comparison between the measurement point A and a measurement point B, the respective items of the related determination key parameter 300 and the respective items of the related determination key parameter 306 are compared with one another. If all the attributes of all the items match with one another, then comparison of the dependent parameters is executed. In the event that there is a difference in the related determination key parameters, an item having the difference is extracted as a differential, and comparison of the dependent parameters is not executed.

In the example shown in FIG. 7, related determination key parameters all match with one another, and there is a difference between an item 305 in the dependent parameter 301 of the measurement point A and an item 308 in a dependent parameter 307 of the measurement point B, a design value 1 is extracted as a differential.

FIG. 8 is a view of an example screen displaying the recipe comparison results. In a screen 400, a total number window 401, a selected recipe list 402, and a differential list 403 are displayed side by side. The total number window 401 displays a total number of portions extracted as differentials. In the illustrated example screen, since there are four recipes respectively having differentials as indicated by the numbers in the differential list 403, “4” is displayed in the total number window 401. The selected recipe list 402 displays a list of recipe data selected in FIG. 7. In the column of Master Recipe of the selected recipe list 402, the device, recipe, wafer map, and measurement point selected from the master recipe field section 201 of FIG. 7 are displayed. Further, for respective recipes subsequent to Recipe 1, the devices, recipes, wafer maps, and measurement points corresponding to the number of recipes selected from the master recipe field section 202 of FIG. 7 are displayed. In the example screen shown in the drawing, Recipes 1 to 5 are displayed. In the differential list 403, differential portions corresponding to the total number 401 are displayed.

In regard to the data items, in the event that recipe data having even a single different value has been detected as a result of comparison between the master recipe data and multiple pieces of recipe data, it is displayed in the differential list 403 as a differential in one portion. In the respective line of the differential list 403, Number, State, Differential, Master Recipe, and recipe data selected from the comparison target recipe selection field section 202 of FIG. 7 are displayed. In the column of the number, the numbers of order of items or portions extracted as differentials are displayed. In the column of the state, any one of Addition, Modification, and Deletion is displayed corresponding to the respective line.

The state of Addition is indicative of the state where while the master recipe data is not present, measurement point data is present in the compared recipe data. The state of Modification is indicative of the state where, while the number of pieces of measurement point data are the same, differentials are inherently present in element parameters associated thereto. The state of Deletion is indicative of the state where measurement point data present in the master recipe data is not present in compared recipe data. Thus, although the differences between the master recipe data and the comparison target recipe data are displayed with the characters “Addition,” “Modification,” and “Deletion,” the differences may be displayed with symbols, characters, or images having or representing meanings equivalent to “Addition,” “Modification,” and “Deletion.”

In the column of Differential, element parameter items of measurement point data are displayed. For example, differentials in the example corresponding to number 4 are present in “IDP” and “3,” and practical values of parameters can be verified and modified on a parameter setting screen as shown in FIG. 10 and further described below. In the differential list 403 of the present embodiment, the parameter items are represented in a hierarchical structure, in which the diagrams are displayed by using the squares and horizontal lines. Alternatively, however, the parameter items may be represented in tree-state diagrams. Still alternatively, the parameter items may be represented by using text and images, for example. In the column of Master Recipe, parameter values of the master recipe data are displayed. When no value is present, “−” is displayed. Alternatively, however, any one of symbols other than “−,” characters, and images may be displayed. Still alternatively, nothing may be displayed. The respective parameter value is displayed with an underline, thereby indicating that the portion of the value can be selected by clicking thereon.

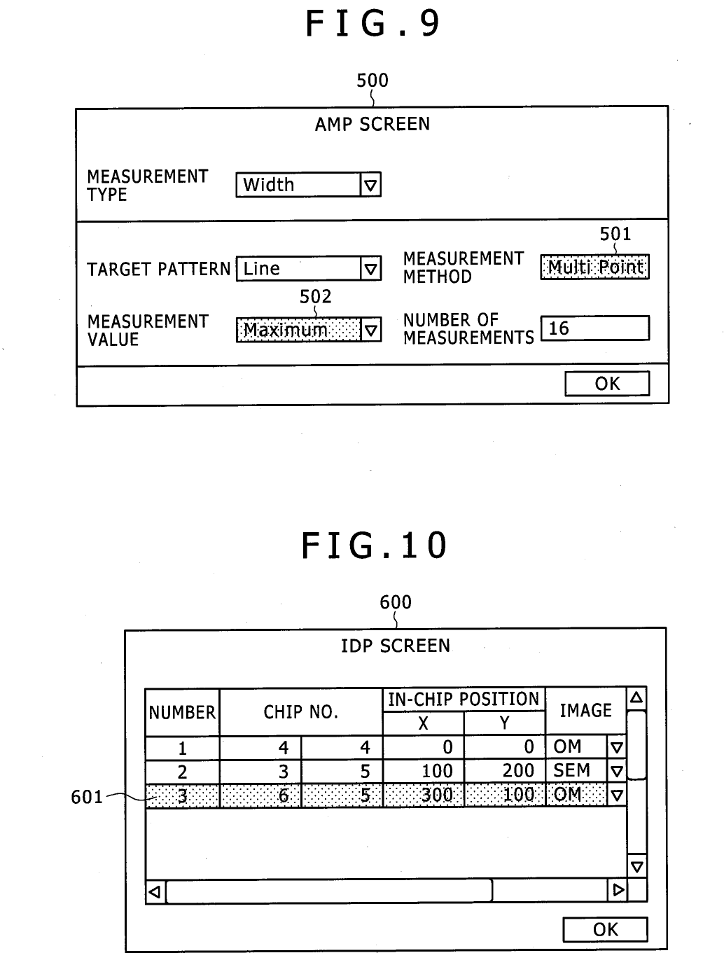

FIGS. 9 and 10, respectively, are edit screens for editing the master recipe including the parameter values of the master recipe data in the column of Master Recipe. The screen such as shown in FIG. 9 is displayed as an example in the event that the parameter value “Multi Point” or “Maximum” in the column of Master Recipe corresponding to number “2” or “3” of the differential list 403 in FIG. 8 is selected by clicking thereon. Further, the screen such as shown in FIG. 10 is displayed in the event that the parameter value “3” in the column of Master Recipe corresponding to number “4” is clicked on. These screens are displayed by being superimposed on FIG. 8. The contents of the respective ones will be described further below. In the present embodiment, in the case where parameter values are related to the edit screen, that is, parameter values are linked to the edit screen, the corresponding screen is displayed by clicking thereon with a mouse. The method may be such that the screen is displayed by double clicking thereon with the mouse or either by depressing a key after changing the state into a selected state through clicking with the mouse or by depressing a button after changing the state into the selected state through clicking thereon with the mouse. Further, as the displaying method for indicating that the parameter values are linked to the edit screen, the method of displaying the underline with the parameter value is employed in the present embodiment. However, the displaying method may be any one of, for example, methods of using the reverse-video display mode, changing the background color, changing the font color, using a bold font, using an oblique or italicized font, changing the font size, and framing selected portions.

In the event that the differences between the master recipe data and the comparison target recipe data are eliminated through editing of the parameter values on the linked screens such as shown in FIGS. 9 and 10, the target differential portions are automatically deleted. The method may be such that the lines are remained automatically undeleted, but the line portions are highlighted in such a manner that the background of the target lines is colored.

In the event that differences are present between the master recipe data and the comparison target recipe data, the values of the differences are displayed in the respective columns of Recipes of the differential list 403. For example, in the case of number “1” of the differential list 403 shown in FIG. 8, the parameter value “2” under Recipe 2 is a value of the difference with respect to the master recipe. The value is highlighted in the manner that the background in the target position is colored. However, the highlighting method may be any one of, for example, methods of using the reverse-video display mode, changing the background color, changing the font color, using a bold font, using an oblique or italicized font, changing the font size, and framing selected portions. As in the column of Recipe 2, when no value is present, “−” is displayed. Alternatively, however, any one of symbols other than “−,” characters, and images may be displayed. Still alternatively, nothing may be displayed. No value is displayed in the portion where no differential is present between the master recipe data and the comparison target recipe data.

An example of the edit screen to be displayed in response to clicking on the parameter value in the column of the comparison target recipe will be described herebelow. FIG. 9 is one example of a screen displayed in response to clicking on the parameter value “Multi Point” or “Maximum” in the column of Master Recipe corresponding to-number “2” or “3” in the differential list 403 shown in FIG. 8. More specifically, the screen is a setting screen for setting the value of a measurement parameter on the linked side. In an AMP screen 500, there are displayed “Width” as a measurement type, “Line” as a target pattern, “Multi Point” as a measurement method, “Maximum” as a measurement value, and “16” as the number of measurement points. In the event that a difference is present in the parameter value between the master recipe data and the comparison target recipe data, a target input item is highlighted in the reverse-video display mode. For example, in a measurement method window 501 and a measurement value window 502, since a difference is present in the parameter between the master recipe data and the comparison target data of Recipe 1, the items are highlighted in the reverse-video display mode. The highlighting method may be any one of, for example, methods of using the reverse-video display mode, changing the background color, changing the font color, using a bold font, using an oblique or italicized font, changing the font size, and framing selected portions.

In the event that the values in the master recipe data and all the values in the comparison target recipe data have been corrected to be identical to one another through editing of the highlighted input items, the display mode changes from the highlight display mode to the normal display mode. The highlighting method may be any one of, for example, methods of using the reverse-video display mode, changing the background color, changing the font color, using a bold font, using an oblique or italicized font, changing the font size, and framing selected portions. In response to depression of the OK button, the edit contents are stored, and the screen shown in FIG. 9 is closed or deactivated. Although the OK button is thus depressed in the present embodiment, the edit contents may be stored from a menu or may be automatically stored upon completion of editing.

When the parameter value “3” in the column of Master Recipe corresponding to number “4” in the differential list 403 shown in FIG. 8 is selected by clicking thereon, a screen such as shown in FIG. 10 is displayed. “IDP” and “3” are displayed in the column of Differential in the differential list 403 shown in FIG. 8. FIG. 10 is an IDP screen 600, in which a line 601 related to number “3” is displayed in the reverse-video display mode. The IDP screen 600 is a screen for the use of setting information regarding measurement targets, such as image information that are used for detection of a measurement inspection chip, measurement point, inspection point, and pattern. In the example screen, since the portion where the parameter values of the master recipe data and the comparison target recipe data are different from one another corresponds to a line 601 of Number 3, the line is highlighted in the reverse-video display mode. In this example case of comparison, when parameter values are present only on one of the data sides, the parameter values on the data side where the values are present are highlighted. For example, in the case of the line 601 of Number 3, parameter values are present on the master recipe data side, so that the line 601 is highlighted. The highlighting method may be any one of not only the method using the reverse-video display mode, but also any one of, for example, methods of using the reverse-video display mode, changing the background color, changing the font color, using a bold font, using an oblique or italicized font, changing the font size, and framing selected portions. In the event that the values in the master recipe data and all the values in the comparison target recipe data have been corrected to be identical to one another through editing of the highlighted input items, the display mode changes from the highlight display mode to the normal display mode. However, the method may be of the type in which, while the display mode is not changed to the normal mode, there is used any one of, for example, methods of using the reverse-video display mode, changing the background color, changing the font color, using a bold font, using an oblique or italicized font, changing the font size, and framing selected portions. In response to depression of the OK button, the edit contents are stored, and the screen shown in FIG. 10 is closed or deactivated. Although the OK button is thus depressed in the present embodiment, the edit contents may be stored from a menu or may be automatically stored upon completion of editing.

As described above, the recipe comparison control device of the present embodiment of the present invention includes the functions that designates and collects comparison target data in regard to recipes for multiple inspection devices, that executes comparison of the data, that associates differential parameters with an operation screen, and that causes automatic activation of a parameter operation screen by specifying differential parameters desired to be modified by the user on the screen. Thereby, efficient unitary recipe management can be realized for recipe management of the inspection devices.

The recipe data designation and collection using the recipe comparison control device are performed for targets between the inspection devices, between the recipe comparison control device and the inspection devices, or between multiple recipes retained in the inspection devices through a communication device (communication means) that transfers recipe data from the multiple inspection devices.

Differentials are detected as a result of correlative comparison of multiple pieces of recipe data being managed in a recipe management table, wafer map table, and measurement point table.

The present embodiment of the present invention employs a one-versus-n (pieces) comparison method that executes comparison between one piece of master recipe data having actual productivity and multiple pieces of recipe data.

In the present embodiment, the recipe data correction is carried out by taking the differential results into account. In this case, since the differential parameter displayed on the display of the recipe comparison control device is selected, the operation screen for displaying corresponding data can be activated in association therewith, so that data modification is facilitated. Consequently, a recipe management system having usability for operators can be obtained.

By virtue of the series of functions of the recipe comparison control device, selection, distribution, and the like of necessary or unnecessary recipes can be made in units of the product type and the inspection step, therefore enabling the implementation of efficient unitary recipe management can be realized for the recipe management of the inspection devices.

As above, while the present invention has been described by way of reference to particular examples, the invention is not limited thereto and various changes and modifications may be made without departing from the spirit and scope of the invention.

### FIG. 1

100 A INSPECTION DEVICE
113 STORAGE DEVICE
130 RECIPE INDEX TABLE
131 A1 RECIPE DATA
132 A2 RECIPE DATA
150 RECIPE MANAGEMENT DATA
151 MEASUREMENT POINT DATA
152 MEASUREMENT POINT DATA
112 INPUT/OUTPUT DEVICE
111 CONTROL DEVICE
110 COMPUTING DEVICE
101A B INSPECTION DEVICE
117 STORAGE DEVICE
B1 RECIPE DATA
B2 RECIPE DATA
116 INPUT/OUTPUT DEVICE
115 CONTROL DEVICE
114 COMPUTING DEVICE
102 RECIPE COMPARISON CONTROL DEVICE
119 INPUT/OUTPUT DEVICE
160 DEVICE SELECTION
161 LIST-DISPLAYED RECIPE SELECTION
162 RECIPE-DATA DIFFERENTIAL RESULT DISPLAY FUNCTION
118 COMPUTING DEVICE
170 LIST DISPLAY ACQUIRING SECTION
171 RECIPE DATA ACQUIRING SECTION
172 RECIPE DATA DIFFERENTIAL DETECTION SECTION
120 STORAGE DEVICE
136 C RECIPE INDEX TABLE 136
137 MASTER RECIPE DATA (Al)
138A B1 RECIPE DATA 138A

### FIG. 2

START
S1001 DEFINE A1 RECIPE DATA AS MASTER RECIPE DATA
S1002 EXTRACT RECIPE MANAGEMENT DATA FROM MASTER RECIPE DATA→MASTER RECIPE MANAGEMENT DATA
S1003 COMPARISON TARGET RECIPE DATA IS PRESENT IN C RECIPE INDEX TABLE?
S1004 EXTRACT RECIPE MANAGEMENT DATA FROM COMPARISON TARGET RECIPE DATA→COMPARISON RECIPE MANAGEMENT DATA
S1005 PARAMETER DIFFERENTIAL HAS OCCURRED IN SERIAL COMPARISON BETWEEN RESPECTIVE PARAMETERS OF MASTER RECIPE MANAGEMENT DATA AND COMPARISON RECIPE MANAGEMENT DATA?
S1006 DISPLAY PARAMETER DIFFERENTIAL
END

### FIG. 3

START
S2001 DEFINE A1 RECIPE DATA AS MASTER RECIPE DATA
S2002 EXTRACT WAFER MAP DATA FROM MASTER RECIPE DATA→MASTER WAFER MAP DATA
S2003 COMPARISON TARGET RECIPE DATA IS PRESENT IN C RECIPE INDEX TABLE?
S2004 EXTRACT WAFER MAP DATA FROM COMPARISON TARGET RECIPE DATA→COMPARISON WAFER MAP DATA
S2005 PARAMETER DIFFERENTIAL HAS OCCURRED IN SERIAL COMPARISON BETWEEN CHIP DATA OF CHIP DATA OF MASTER WAFER MAP DATA AND COMPARISON WAFER MAP DATA?
S2006 DISPLAY PARAMETER DIFFERENTIAL
END

### FIG. 4

START
S3001 DEFINE A1 RECIPE DATA AS MASTER RECIPE DATA
S3002 EXTRACT MEASUREMENT POINT DATA FROM MASTER RECIPE DATA→MASTER MEASUREMENT POINT DATA
S3003 COMPARISON TARGET RECIPE DATA IS PRESENT IN C RECIPE INDEX TABLE?
S3004 EXTRACT MEASUREMENT POINT DATA FROM COMPARISON TARGET RECIPE DATA→COMPARISON MEASUREMENT POINT DATA
S3005 COMPARISON BETWEEN THE NUMBERS OF PIECES OF MEASUREMENT POINT DATA HAS BEEN EXECUTED?
S3006 MEASUREMENT POINT DATA IS PRESENT ONLY ON ONE SIDE OF MASTER MEASUREMENT POINT DATA AND COMPARISON MEASUREMENT POINT DATA?
S3007 DISPLAY INFORMATION REGARDING PRESENCE OF MEASUREMENT POINT DATA ONLY ON ONE SIDE
S3008 PARAMETER DIFFERENTIAL HAS OCCURRED IN SERIAL COMPARISON BETWEEN RESPECTIVE PARAMETERS OF MASTER MEASUREMENT POINT DATA AND COMPARISON MEASUREMENT POINT DATA?
S3009 DISPLAY PARAMETER DIFFERENTIAL
S3010 ACQUIRE MEASUREMENT POINT DATA OF SUBSEQUENT ELEMENT
END

### FIG. 5

START
S4001 MATCH HAS BEEN FOUND BETWEEN THE NUMBERS OF RELATED KEY PARAMETERS OF MASTER MEASUREMENT POINT DATA AND COMPARISON MEASUREMENT POINT DATA?
S4002 SUBSEQUENT RELATED DETERMINATION KEY PARAMETER IS PRESENT?
S4003 IN COMPARISON BETWEEN RELATED DETERMINATION KEY PARAMETERS, PARAMETER VALUES MATCH WITH ONE ANOTHER?
S4004 ACQUIRE SUBSEQUENT RELATED DETERMINATION KEY PARAMETER
S4005 PERFORM SERIAL COMPARISON BETWEEN DEPENDENT PARAMETERS
S4006 PARAMETER DIFFERENTIAL HAS OCCURRED IN SERIAL COMPARISON BETWEEN DEPENDENT PARAMETERS OF MASTER MEASUREMENT POINT DATA AND COMPARISON MEASUREMENT POINT DATA?
S4007 DISPLAY PARAMETER DIFFERENTIAL
END

### FIG. 6

Master Recipes

| Recipe | Wafer Map | Measurement Point |
|---|---|---|
| Device | | |
| 201 | | |
| 203 Inspection device A | | |
| 204 | | |
| Recipe A1 | Wafer map 1 | Measurement point 1 |
| Recipe A2 | Wafer map 1 | Measurement point 2 |
| Recipe A3 | Wafer map 1 | Measurement point 3 |
| Recipe A4 | Wafer map 2 | Measurement point 1 |
| Recipe A5 | Wafer map 2 | Measurement point 2 |
| Recipe A6 | Wafer map 2 | Measurement point 3 |
| Recipe A7 | Wafer map 3 | Measurement point 1 |
| Recipe A8 | Wafer map 3 | Measurement point 2 |
| 202 | | |
| 208 Device | | |
| 205 Inspection device A | | |
| Recipe A1 | Wafer map 1 | Measurement point 1 |
| Recipe A2 | Wafer map 1 | Measurement point 2 |
| Recipe A3 | Wafer map 1 | Measurement point 3 |
| Recipe A4 | Wafer map 2 | Measurement point 1 |
| Recipe A5 | Wafer map 2 | Measurement point 2 |
| Recipe A6 | Wafer map 2 | Measurement point 3 |
| 206 Inspection device B | | |
| Recipe B1 | Wafer map 4 | Measurement point 4 |
| Recipe B2 | Wafer map 4 | Measurement point 5 |
| Recipe B3 | Wafer map 4 | Measurement point 6 |
| Recipe B4 | Wafer map 5 | Measurement point 4 |
| Recipe B5 | Wafer map 5 | Measurement point 5 |
| Recipe B6 | Wafer map 5 | Measurement point 6 |
| 207 Inspection device C | | |
| Recipe A1 | Wafer map 7 | Measurement point 7 |
| Recipe A2 | Wafer map 7 | Measurement point 8 |
| Recipe A3 | Wafer map 7 | Measurement point 9 |
| Recipe A4 | Wafer map 8 | Measurement point 7 |
| Recipe A5 | Wafer map 8 | Measurement point 8 |
| Recipe A6 | Wafer map 8 | Measurement point 9 |

### FIG. 7

300
[symbol] Measurement Point A
[symbol] Measurement Type
[symbol] Measurement Target
[symbol] Measurement Point B
[symbol] Measurement Type
[symbol] Measurement Target
[symbol] Threshold Value 1
[symbol] Design Value 1

### FIG. 8

401
[symbol] Total No.

| | Master | | | | | |
|---|---|---|---|---|---|---|
| | Recipe | Recipe 1 | Recipe 2 | Recipe 3 | Recipe 4 | Rec [symbol] |
| Device | Inspection | Inspection | Inspection | Inspection | Inspection | Ins [symbol] |
| | Device A | DeviceA | Device A | Device C | Device C | Dev [symbol] |
| Recipe | Recipe Data | Recipe Data | Recipe Data | Recipe Data | Recipe Data | Rec [symbol] |
| | A1 | A4 | B1 | B1 | B1 | B1 |
| Wafer Map | Wafer Map 1 | Wafer Map 2 | Wafer Map 1 | Wafer Map 1 | Wafer Map 1 | Waf [symbol] |
| Measurement | Measurement | Measurement | Measurement | Measurement | Measurement | Mea [symbol] |
| Point | Point 1 | Point 1 | Point 1 | Point 1 | Point 1 | Poi [symbol] |

[symbol]

indicates data missing or illegible when filed

[symbol] Number
[symbol] State
[symbol] Differential
[symbol] Measurement Method
[symbol] Measurement Value
[symbol] Master Recipe
[symbol] Recipe 1
[symbol] Recipe 2

### FIG. 9

500 AMP Screen
[symbol] Measurement Type
[symbol] Target Pattern
[symbol] Measurement Method
[symbol] Measurement value
[symbol] Number of Measurements

### FIG. 10

600 IDP Screen
[symbol] Number
[symbol] Chip No.
[symbol] In-chip Position
[symbol] Image

What is claimed is:

1. A data processing system for managing data of inspection conditions of a plurality of inspection devices, the data processing system comprising:
a storage device;
a computing device; and
an input/output device, wherein
the storage device stores therein data of master inspection conditions of one of the plurality of inspection devices for use as reference data in data comparison and data of comparison target inspection conditions of one or more of the others of the plurality of inspection devices;
the input/output device displays thereon names of the master inspection conditions and names of the comparison target inspection conditions in the form of lists arranged side by side, and concurrently displays thereon one of the master inspection conditions and a selected comparison target inspection condition(s) of a comparison target inspection device(s) in a display mode distinguished from a display mode applied for other inspection conditions.

2. A data processing system according to claim 1, wherein the computing device performs a comparison between data of selected one of the master inspection conditions and data of selected one of the comparison target inspection conditions, and causes data including a difference to be displayed onto the input/output device.

3. A data processing system according to claim 2, wherein the data including the difference is a parameter of the inspection condition.

4. A data processing system according to claim 2, wherein the input/output device displays thereon the data including the difference together with other data of the inspection condition including the data.

5. A data processing system according to claim 4, wherein the data including the difference and the other data are parameters of the inspection condition.

6. A data processing system according to claim 4, wherein, when the data of the inspection condition including the difference and displayed on the input/output device is corrected and the difference is eliminated thereby, the computing device ceases causing the inspection condition displayed on the input/output device to be displayed in the display mode distinguished from the display mode applied for the other inspection conditions.

7. A data processing system according to claim 1, wherein the storage device stores therein a recipe index table allowing the data of the master inspection conditions and the data of the comparison target inspection conditions to be searched.

8. A data processing system according to claim 7, wherein, when the data of the master inspection conditions and the data of the comparison target inspection conditions match with one another, the data of the master inspection conditions is updated by being overwritten with the comparison target inspection conditions; but when no match is present between the data of the master inspection conditions and the data of the comparison target inspection conditions, the data of the comparison target inspection conditions is newly stored into the recipe index table.

9. A data processing system for managing data of inspection conditions of a plurality of inspection devices, the data processing system comprising:
a storage device;
a computing device; and
an input/output device,
wherein the computing device performs designation and collection of comparison target data in regard to inspection conditions of the plurality of inspection devices, performs a comparison of data, causes a differential parameter obtained as a result of the comparison and an operation screen displayed on the input/output device to be displayed in association with one another, and causes displaying a parameter operation screen for operating a parameter of an inspection condition inclusive of a differential parameter specified on a screen of the input/output device.

10. A data processing system according to claim 9, wherein the inspection conditions have a tree structure wherein a related determination key parameter including one piece of measurement type data and one or more pieces of measurement target data is set as a high order level and a dependent parameter including a design value and a threshold value is set as a low order level, wherein a comparison by the computing device is performed in a manner that data of the related determination key parameter of a first inspection condition is compared with data of the related determination key parameter of a second inspection condition, and a comparison of dependent parameters is performed when all the data match with one another.
